(19) United States
(12) Patent Application Publication
(10) Pub. No.: US 2018/0167711 A1
(43) Pub. Date: Jun. 14, 2018

(54) EARPHONE

(71) Applicant: Merry Electronics(Shenzhen) Co., Ltd., Guangdong (CN)

(72) Inventor: Chia-Chung Lin, Taichung (TW)

(73) Assignee: Merry Electronics(Shenzhen) Co., Ltd., Guangdong (CN)

(21) Appl. No.: 15/693,492

(22) Filed: Sep. 1, 2017

(30) Foreign Application Priority Data
Dec. 9, 2016 (TW) 105140840

(51) Int. Cl. H04R 1/10

(52) U.S. Cl. CPC H04R 1/1016; H04R 2460/09; H04R 1/1075

(57) ABSTRACT

An earphone including a housing, a first speaker and an audio outlet is provided. The housing includes an insertion end and a main body. The insertion end is into the entrance of a user's ear when worn by the user, and the main body extends from the insertion end and defines an auricle contact surface and an external connecting surface opposite to the auricle contact surface. The auricle contact surface faces the user's auricle and the external connecting surface communicates to the external environment when the earphone is worn. The first speaker is contained within the main body to divide into a front chamber and a first rear chamber. A part of the first rear chamber is adjacent to the auricle contact surface. A sound output surface of the first speaker faces the external connecting surface. The audio outlet is formed in the insertion end to let out the sound.

### CROSS-REFERENCE TO RELATED APPLICATION

This application claims the priority benefit of Taiwan application serial no. 105140840, filed on Dec. 9, 2016. The entirety of the above-mentioned patent application is hereby incorporated by reference herein and made a part of this specification.

### BACKGROUND OF THE INVENTION

### 1. Field of the Invention

The invention is related to an earphone.

### 2. Description of Related Art

With advancement of technologies, the current trends in electronic products are compact and light designs. Compact-sized electronic products such as radios, Walkman or smart phones are used at any time everywhere. No matter what electronic product is used, in order for users to listen to audio information sent from the electronic product without disturbing other people, earphones are made as essential accessories for electronic products.

In general, for earphones with smaller volume, such as in-ear or half in-ear earphones, in order for users to obtain better sound quality, sound output surfaces of speakers of the earphones are usually set to face towards the sound outlets; as a result, available spaces inside the earphone with smaller volume are limited, thereby making it difficult for the earphones to have a variety of functions. Therefore, it is an issue to be solved by persons skilled in the art to improve the structures of the earphones to enable the earphones to have different functions while maintaining their sound quality.

### SUMMARY OF THE INVENTION

The invention is directed to an earphone, which is capable of flexibly utilizing an internal space of the earphone so as to enable the earphone to maintain its sound quality in addition to having a variety of functions.

The earphone of the invention includes a housing, a first speaker and an audio outlet. The housing includes an insertion end and a main body. The insertion end is into the entrance of a user's ear when worn by the user. The main body extends from the insertion end and defines an auricle contact surface and an external connecting surface opposite to the auricle contact surface. The auricle contact surface of the main body faces the auricle of the user, and the external connecting surface communicates to an external environment when the earphone is worn. The first speaker is contained within the main body of the housing to divide the main body into a front chamber and a first rear chamber. A part of the first rear chamber of the main body is adjacent to the auricle contact surface of the main body. A sound output surface of the first speaker faces the external connecting surface of the housing. The audio outlet is formed in the insertion end of the housing so as to let out the sound.

In an embodiment of the invention, the earphone further includes a first tuning hole. The first tuning hole is formed in the main body of the housing so as to communicate the first rear chamber with the external environment.

In an embodiment of the invention, the earphone further includes a partition. The partition is disposed inside the main body of the housing and between the external connecting surface and the first speaker. The partition and the external connecting surface define an accommodation space therebetween.

In an embodiment of the invention, the earphone further includes at least a functional element. The functional element is located inside the accommodation space.

In an embodiment of the invention, the earphone further includes a front chamber tuning hole. The front chamber tuning hole is formed in the external connecting surface of the main body of the housing so as to communicate the front chamber with outside of the housing.

In an embodiment of the invention, the earphone further includes a partition and a second speaker. The partition is disposed inside the main body of the housing and located between the external connecting surface and the first speaker. The second speaker is contained within the housing and connected between the partition and the main body. The partition and the second speaker and the first speaker share the front chamber with the first speaker, and a second rear chamber is defined by the second speaker and the external connecting surface.

In an embodiment of the invention, the earphone further includes a second tuning hole. The second tuning hole is formed in the external connecting surface of the main body of the housing so as to communicate the second rear chamber with outside of the housing.

In an embodiment of the invention, the earphone further includes a baffle. The baffle is located between the auricle contact surface of the main body and the first speaker and communicates to the front chamber.

In view of the above, in the earphone of the invention, the first speaker is contained within the main body of the housing so as to divide the main body into the front chamber and the first rear chamber. Further, a part of the first rear chamber of the main body is adjacent to the auricle contact surface of the main body. Under such configuration, the earphone of the invention has the accommodation space for installing other functional elements and also has more spatially varying applications, and thus the earphone may have a variety of functions.

In order to make the aforementioned features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating an earphone according to a first embodiment of the invention.

FIG. 2 is a schematic view illustrating an earphone according to a second embodiment of the invention.

FIG. 3A and FIG. 3B are schematic views respectively illustrating an earphone according to a third embodiment of the invention.

FIG. 4A to FIG. 4D are schematic views respectively illustrating an earphone according to a fourth embodiment of the invention.

### DESCRIPTION OF THE EMBODIMENTS

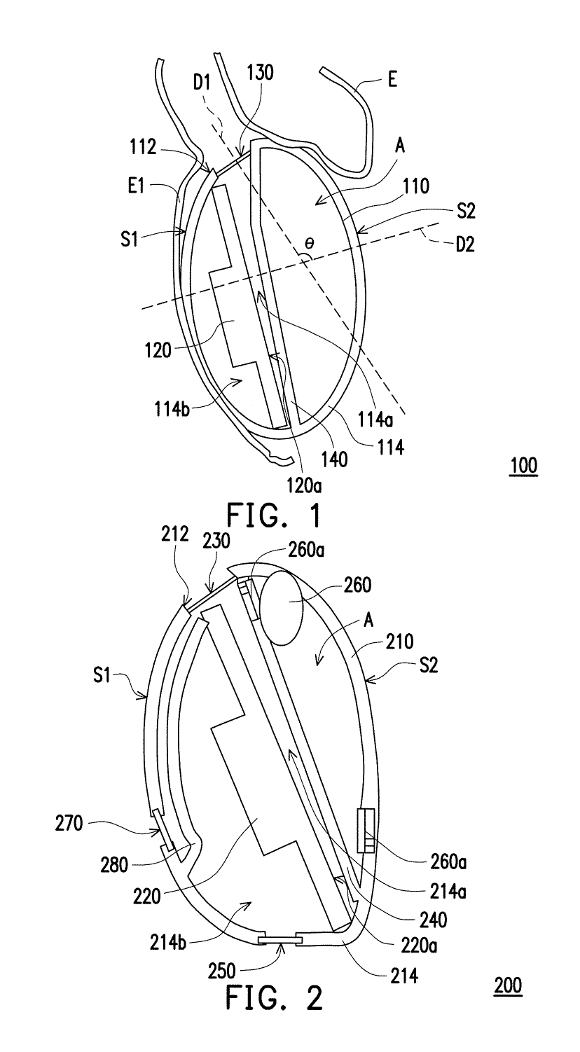

FIG. 1 is a schematic view illustrating an earphone 100 according to a first embodiment of the invention. Referring to FIG. 1, the earphone 100 of the present embodiment includes a housing 110, a first speaker 120 and an audio outlet 130. The housing 110 includes an insertion end 112 and a main body 114. The insertion end 112 may be inserted into the entrance of a user's ear E when worn by the user. The main body 114 extends from the insertion end 112 and defines an auricle contact surface S1 and an external connecting surface S2 opposite to the auricle contact surface S1. The auricle contact surface S1 of the main body 114 faces towards an auricle E1 of the user, and the external connecting surface S2 communicates to an external environment when the earphone 100 is worn. The first speaker 120 is contained within the main body 114 of the housing 110 to divide the main body 114 into a front chamber 114a and a first rear chamber 114b. A part of the first rear chamber 114b of the main body 114 is adjacent to the auricle contact surface S1 of the main body 114. That is, at least a part of the first rear chamber 114b of the main body 114 is adjacent to the auricle contact surface S1 of the main body 114. Further, a sound output surface 120a of the first speaker 120 faces towards the external connecting surface S2 of the housing 110. The audio outlet 130 is formed in the insertion end 112 of the housing 110 so as to let out the sound from the first speaker 120.

In addition, in the present embodiment, an included angle θ between an extending direction D1 of the audio outlet 130 and a normal direction D2 of the first speaker 120 is greater than or equal to 90 degrees. It can be noted that, in other embodiments, the included angle θ between the extending direction D1 of the audio outlet 130 and the normal direction D2 of the first speaker 120 may also be set as less than 90 degrees depending on the actual design requirements. Moreover, in the present embodiment, the earphone 100 further includes a partition 140. The partition 140 is disposed inside the main body 114 of the housing 110 and between the external connecting surface S2 and the first speaker 120. The partition 140 and the external connecting surface S2 define an accommodation space A therebetween. In other words, the front chamber 114a is a space between the first speaker 120 and the accommodation space A, and the disposition of the partition 140 may be adjusted depending on the actual design requirements so as to change a size of volume of the front chamber 114a. In general, the smaller the volume of the front chamber 114a, the more conducive for enhancing the high-frequency response, as well as for enhancing the effect of sound quality.

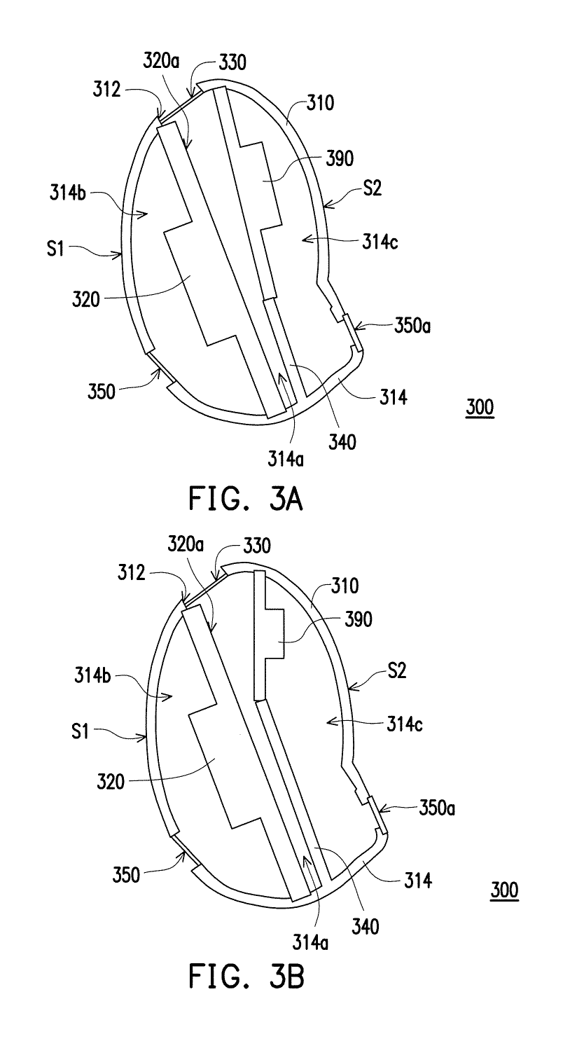

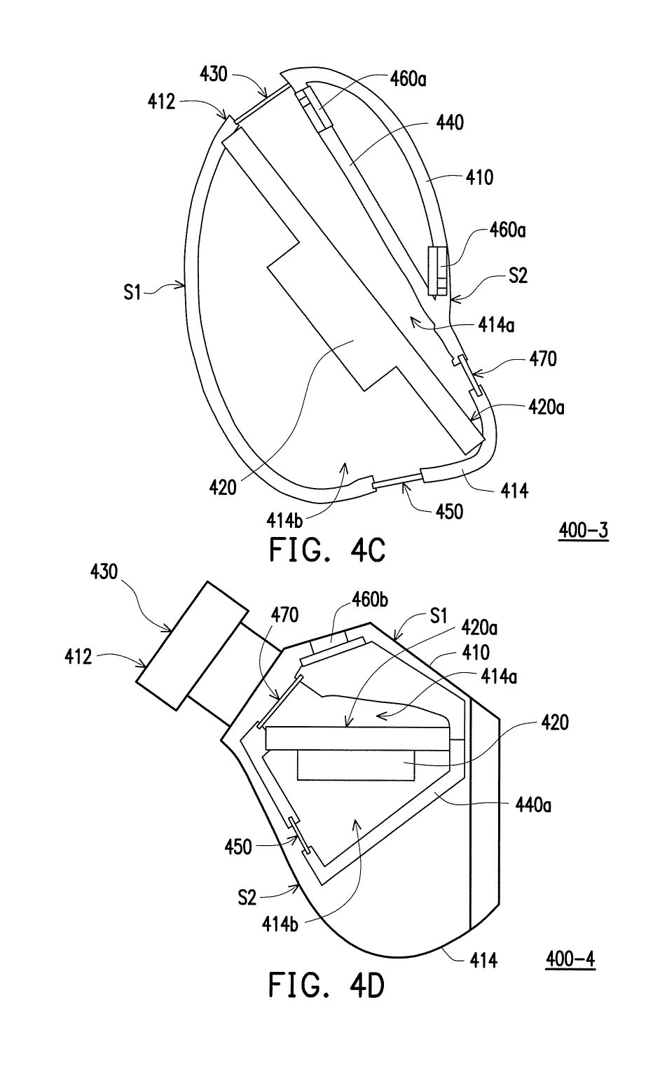

FIG. 2 is a schematic view illustrating an earphone 200 according to a second embodiment of the invention. Referring to FIG. 1 and FIG. 2, identical or similar numbers refer to identical or similar elements throughout the drawings, and no repetition will be incorporated in the descriptions. The earphone 200 of the present embodiment is similar to the earphone 100 of FIG. 1, except that a main difference therebetween, for example, lies in that the earphone 200 further includes a first tuning hole 250 and at least one functional element 260. In addition, the first tuning hole 250 is formed in the main body 214 of the housing 210 so as to communicate the first rear chamber 214b with outside of the housing 210. The functional element 260 is located inside the accommodation space A. For instance, the functional element 260 includes an active noise cancellation (ANC) element 260a, a heart rate monitor (HRM) (refer to 460b in FIG. 4D) or other sensing elements.

In the present embodiment, the earphone 200 further includes a front chamber tuning hole 270. The front chamber tuning hole 270 is, for example, formed in the auricle contact surface S1 of the main body 214 so as to communicate the front chamber 214a with outside of the housing 210. With the disposition of the front chamber tuning hole 270, a sense of occlusion may be prevented when the user wears the earphone for a long-time. In addition, the earphone 200 further includes a baffle 280. The baffle 280 is located between the auricle contact surface S1 of the main body 214 and the first speaker 220 and communicates to the front chamber 214a. Two ends of the baffle 280 are respectively connected to the first speaker 220 and the housing 210, and an inclination angle of the first speaker 220 may be adjusted by the baffle 280. It is to be explained that, the design of the baffle 280 as shown in FIG. 2 is merely provided as an example and should not be construed as a limitation to the invention.

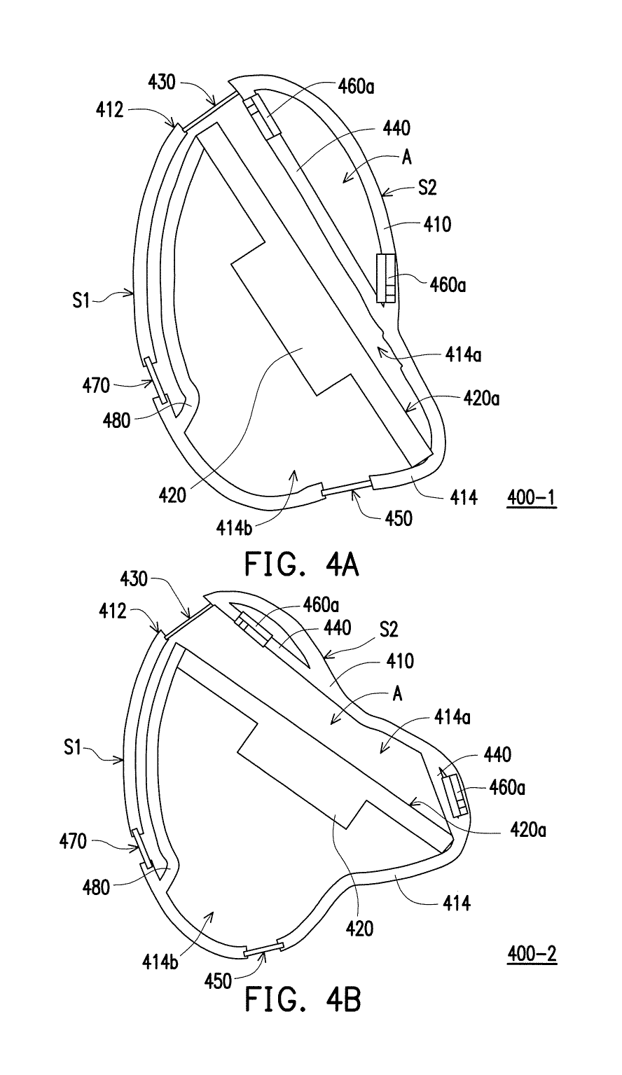

FIG. 3A and FIG. 3B are schematic views respectively illustrating an earphone 300 according to a third embodiment of the invention. Referring to FIG. 1, FIG. 3A and FIG. 3B, identical or similar numbers refer to identical or similar elements throughout the drawings, and no repetition will be incorporated in the descriptions. The earphone 300 of the present embodiment is similar to the earphone 100 of FIG. 1, except that a main difference between the two, for example, lies in that the earphone 300 further includes a second speaker 390. The second speaker 390 is contained within the housing 310 and connected between the partition 340 and the main body 314. A sound output surface of the second speaker 390 may be disposed as facing towards the audio outlet 330. That is to say, the sound output surface 320a of the first speaker 320 and the sound output surface of the second speaker 390 are facing towards each other. In addition, a size of the second speaker 390 is, for example, smaller than a size of the first speaker 320. As such, the first speaker 320 and the second speaker 390 may be used to emit sound waves of different frequency bands; for instance, the first speaker 320 is responsible for a low or medium-low pitch sound range, while the second speaker 390 is responsible for a high pitch sound range. Since the earphone 300 has both the first speaker 320 and the second speaker 390, the overall frequency response range of the earphone 300 may be expanded, thereby providing a favorable sound quality performance.

In the present embodiment, the partition 340 is between the external connecting surface S2 and the first speaker 320. The partition 340 and the second speaker 390 share the front chamber 314a with the first speaker 320, and a second rear chamber 314c is defined by the second speaker 390, the partition 340 and the external connecting surface S2. In the present embodiment, the earphone 300 further includes a first tuning hole 350 and a second tuning hole 350a. The first tuning hole 350 is formed in the auricle contact surface S1 of the main body 314 of the housing 310 so as to communicate the first rear chamber 314b with outside of the housing 310. The second tuning hole 350a is formed in the external connecting surface S2 of the main body 314 of the housing 310 so as to communicate the second rear chamber 314c with outside of the housing 310.

A main difference between FIG. 3A and FIG. 3B lies in the size and the disposition of the second speaker 390. In addition, in the embodiment of FIG. 3B, the second speaker 390 is, for example, a speaker of smaller size, which enables the sound output surface of the second speaker 390 is more close to the audio outlet 330, so that the second speaker 390 is more close to the user's eardrum, and thus is capable of providing a high-quality sound output of high pitch sound range. Relative positions and sizes of the first speaker 320 and the second speaker 390 may all be adjusted depending on the actual design requirements so as to meet the different demands of the user in terms of sound quality or timbre, and should not be construed as a limitation to the invention. In one embodiment, the earphone 300 may also include a front chamber tuning hole (not shown). The front chamber tuning hole is, for example, provided on the main body 314 between the first speaker 320 and the second speaker 390 so as to communicate the front chamber 314a with outside of the housing 310.

FIG. 4A, FIG. 4B, FIG. 4C and FIG. 4D are schematic views respectively illustrating an earphone 400-1, 400-2, 400-3, 400-4 according to a fourth embodiment of the invention. Referring to FIG. 1, FIG. 2 and FIG. 4A to FIG. 4D, identical or similar numbers refer to identical or similar elements throughout the drawings, and no repetition will be incorporated in the descriptions. The earphone 400-1 of the present embodiment is similar to the earphone 200 of FIG. 2, except that a main difference between the two, for example, lies in that the first speaker 420 of the earphone 400-1 may change its size and its included angle θ depending on the earphone appearance or different requirements of high or low frequency. In addition, depending on the number, the type or the size of the functional elements, the size of the accommodation space A may also adjusted in coordination with the partition 440, so that the earphone 400-1 has a variety of different space applications and changes.

Next, a difference between the earphone 400-2 of FIG. 4B and the earphone 400-1 of FIG. 4A, for example, lies in that the earphone 400-2 of FIG. 4B may be configured with a larger first speaker 420, and an inclination angle of the first speaker 420 relative to the auricle contact surface S1 is greater. Therefore, when the user wears the earphone 400-2, a part of the earphone 400-2, for example, exceeds beyond the user's cavum conchae (not shown). The first speaker 420 with a larger volume may provide a better low frequency response, and thereby enables the user to obtain a different auditory experience. Moreover, the earphone 400-2 may further be configured with two partitions 440 inside the main body 414 of the housing 410, and the invention does not intend to limit the number of the partition. In the present embodiment, the two active noise cancellation elements 460a may be respectively disposed on the two partitions 440 and be both located in the accommodation space A. For instance, one of the active noise cancellation components 460a may be disposed near the audio outlet 430 to receive noises inside the ear canal, while the other one of the active noise cancellation elements 460a may have its sound receiving hole faced towards the outside to receive noises from the external environment. Under such configuration, noises can be collected more comprehensively, thereby achieving a better noise reduction effect.

Further, a difference between the earphone 400-3 of FIG. 4C and the earphone 100 of FIG. 1, for example, lies in that the earphone 400-3 of FIG. 4C includes a front chamber tuning hole 470 and a first tuning hole 450. The front chamber tuning hole 470 is formed in the external connecting surface S2 of the main body 414 of the housing 410 so as to communicate the front chamber 414a with outside of the housing 410. The first tuning hole 450 is formed in the main body 414 of the housing 410 so as to communicate the first rear chamber 414b with outside of the housing 410. In other words, as compared to the earphone 400-1 of FIG. 4A, the front chamber tuning hole 470 of the earphone 400-3 of FIG. 4C is disposed on the external connecting surface S2. With the differences in disposition of the front chamber tuning hole 470, the earphone may be balanced with respect to high frequency and low frequency, and thereby enables the user to have a better sound quality.

Moreover, a difference between the earphone 400-4 of FIG. 4D and the earphone 200 of FIG. 2, for example, lies in that the earphone 400-4 of FIG. 4D includes a heart rate monitoring sensor 460b. Since heart rate is a very important physiological indicator for human body exercise, a result of heart rate sensing not only can be used to evaluate the user's physical condition but also can be used to determine the user's cardiopulmonary function, thereby serving as an exercise intensity indicator, energy consumption or sport training effect evaluation and so forth. Therefore, by disposing the heart rate monitoring sensor 460b inside the accommodation space in the earphone 400-4, the space inside the earphone 400-4 may be effectively used. The structure of the earphone 400-4 is simple and high in practicality. In addition, an included angle between a plane on which the heart rate monitoring sensor 460b locates and the sound output surface 420a of the first speaker 420 may also be adjusted depending on the earphone appearance and the actual configurational condition, and should not be construed as a limitation to the invention.

In summary, the earphone of the invention, by adjusting a configuration direction of the first speaker and using the baffle or the partition to define the accommodation space so as to further dispose the functional elements in the accommodation space, enables the earphone to have a variety of functions while maintaining its sound quality. In addition, under the configuration in which the sound output surface of the first speaker is facing towards the external connecting surface, a center of gravity of the overall earphone may be leaned towards the auricle contact surface, namely, leaned towards the user's ear, and thus the earphone does not easily fall off when being worn by the user.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An earphone, comprising:
a housing comprising an insertion end and a main body, the insertion end into the entrance of a user's ear when worn by the user, the main body extending from the insertion end and defining an auricle contact surface and an external connecting surface opposite to the auricle contact surface, and the auricle contact surface of the main body facing an auricle of the user and the external connecting surface communicating to an external environment when the earphone is worn;
a first speaker contained within the main body of the housing to divide the main body into a front chamber and a first rear chamber, wherein a part of the first rear chamber of the main body is adjacent to the auricle contact surface of the main body, and a sound output surface of the first speaker faces the external connecting surface of the housing; and
an audio outlet formed in the insertion end of the housing so as to let out the sound.

2. The earphone as recited in claim 1, further comprising:
a first tuning hole formed in the main body of the housing so as to communicate the first rear chamber with the external environment.

3. The earphone as recited in claim 1, further comprising:
a partition, disposed inside the main body of the housing and between the external connecting surface and the first speaker, wherein the partition and the external connecting surface define an accommodation space therebetween.

4. The earphone as recited in claim 3, further comprising:
at least a functional element, located inside the accommodation space.

5. The earphone as recited in claim 1, further comprising:
a front chamber tuning hole, formed in the external connecting surface of the main body of the housing so as to communicate the front chamber with outside of the housing.

6. The earphone as recited in claim 1, further comprising:
a partition, disposed inside the main body of the housing and located between the external connecting surface and the first speaker; and
a second speaker, disposed inside the housing and connected between the partition and the main body, wherein the partition and the second speaker share the front chamber with the first speaker, and a second rear chamber is defined by the second speaker and the external connecting surface.

7. The earphone as recited in claim 6, further comprising:
a second tuning hole, formed in the external connecting surface of the main body of the housing so as to communicate the second rear chamber with outside of the housing.

8. The earphone as recited in claim 1, further comprising:
a baffle, located between the auricle contact surface of the main body and the first speaker and communicates to the front chamber.
